(19) United States
(12) Patent Application Publication
(10) Pub. No.: US 2019/0070814 A1
(43) Pub. Date: Mar. 7, 2019

(54) METHOD OF BUILDING TIRES

(71) Applicant: The Goodyear Tire & Rubber Company, Akron, OH (US)

(72) Inventors: George Michael STOILA, Tallmadge, OH (US); Michael James HOGAN, Tallmadge, OH (US); Frank Anthony KMIECIK, Akron, OH (US); Minwu YAO, Hudson, OH (US); Mark John MONTGOMERY, Rootstown, OH (US); Dennis Alan LUNDELL, Akron, OH (US); Kenneth Dean CONGER, Stow, OH (US); Pablo Rafael MORALES, Brimfield, OH (US); Andrew Robert ONDO, Pulaski, PA (US); Richard David VARGO, Cuyahoga Falls, OH (US)

(21) Appl. No.: 15/693,783

(22) Filed: Sep. 1, 2017

(51) Int. Cl. B29D 30/24; B29D 30/32

(52) U.S. Cl. CPC B29D 30/246; B29K 2875/00; B29D 2030/3214; B29D 30/32

(57) ABSTRACT

A method of forming a tire having a first and second bead on a tire building drum is disclosed. The method includes the steps of applying a green tire carcass onto the tire building drum, said tire building drum having a left and right hub, each hub having a bead pocket. The method includes the steps of placing the first and second bead onto a first and second respective bead pocket of the tire building drum and then inflating the carcass into engagement with a belt and tread package while moving at least one of the left and right hubs in the axial direction at a controlled velocity towards the other respective hub.

### FIELD OF THE INVENTION

The invention relates to building tires, and more particularly to an improved method for shaping tires.

### BACKGROUND OF THE INVENTION

The manufacture of tires typically involves a tire building drum wherein numerous tire components are applied to the drum in sequence, forming a cylindrical shaped tire carcass. The tire building drum may be a flat drum, unistage drum, a first stage drum or a high crown tire building drum. In either case, tire components are added onto the drum in succession in order to form a cylindrically shaped first stage green carcass. Next a shaping operation is performed to transform the cylindrical green carcass into a toroidally shaped green tire. Typically, high pressure, low volume shaping air is utilized when shaping the tire, wherein the beads are brought together rapidly. Inherent stresses are created in the green tire, particularly in the apex, bead area and sidewall due to the large compression forces and compound strain applied to the carcass in order to force the components into the desired toroidal shape. These inherent residual stresses can cause tire non-uniformity, poor handling and lower rolling resistance. Thus, an improved tire building process is thus desired that minimizes the residual tire building stresses resulting in an improved tire is desired.

### SUMMARY OF THE INVENTION

The invention provides in a first aspect a method of forming a tire having a first and second bead on a tire building drum comprising the steps of: applying a green tire carcass onto the tire building drum, said tire building drum having a left and right hub, each hub having a bead pocket; placing the first and second bead onto a first and second respective bead pocket of the tire building drum; inflating the carcass into engagement with a belt and tread package while moving at least one of the left and right hubs in the axial direction at a controlled velocity towards the other respective hub.

### Definitions

For ease of understanding this disclosure, the following items are defined:

“Apex” means an elastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least one annular layer or plies of parallel cords, woven or unwoven, underlying the tread and unanchored to the bead.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a perspective view of a second stage tire building drum.

FIG. 2 is a side cross-sectional view of the tire building drum shown in FIG. 1;

FIG. 3 is a cross-sectional view of the bead receiving mechanism of the tire building drum shown in FIG. 2;

FIGS. 4 and 5 are alternate embodiments of the bead pockets.

FIG. 6 is a cross-sectional view of the green tire carcass mounted in the bead pockets of the tire drum.

FIG. 7 illustrates the carcass undergoing low pressure, high volume shaping before the tread and belt package is applied.

FIG. 8 illustrates the green tire carcass inflating into the belt and tread package, with the green tire carcass shown in phantom.

FIG. 9 illustrates the tire formed by shaping and inflation, with the green tire carcass shown in phantom.

### DETAILED DESCRIPTION OF THE INVENTION

The invention provides a new and improved tire building drum that reduces the residual stresses in the green tire carcass, resulting in an improved tire. The process provides that the tire ply and components are shaped into a catenary structure. A catenary structure is a structure that has no tensile or compressive reactions at the base of the structure, and has uniform strain along the length of the structure. In the case of a tire, the beads are the base of the structure and the length from the bead to the crown has uniform strain.

The tire building drum of the present invention allows the tire to be built into a catenary shape, producing a tire that has a bead area and sidewall made with minimal strain. The tire building drum allows the tire to be built so that the ply cords that have the shortest cord length which are maintained in tension, and not compression. The tire building drum also prevents ply cord trisomy, or the unraveling of the cords due to the cords being loaded in compression and not tension.

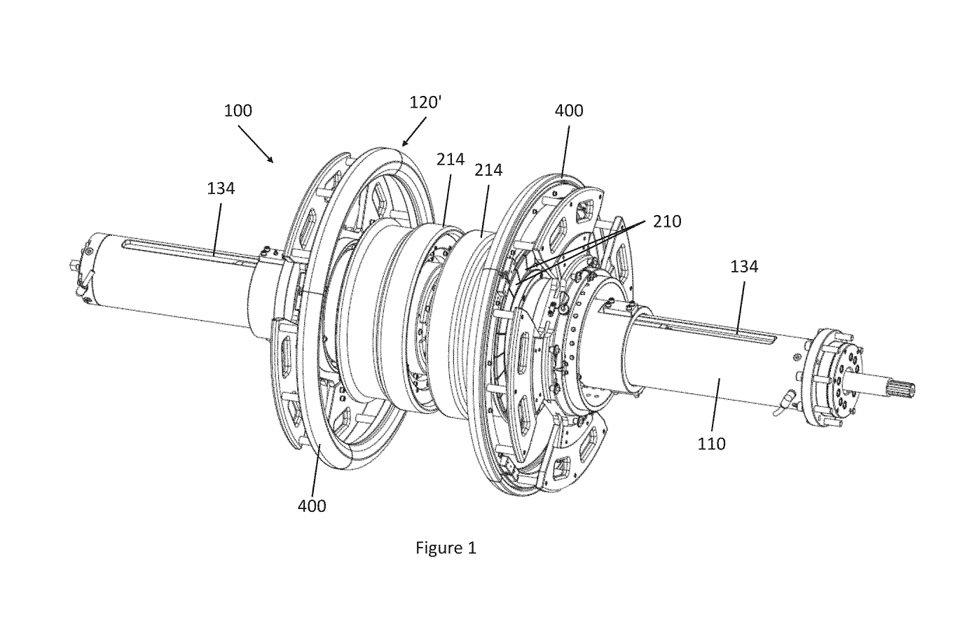

A first embodiment of a second stage tire building drum 100 of the present invention is shown in FIG. 1. The tire building drum 100 has a central shaft 110 with a left hub 120′ and a right hub 120 mounted on the central shaft 110. The left hub 120′ is the mirror image of the right hub 120, and are otherwise mechanically identical except for the orientation. As shown in FIG. 1 and FIGS. 2-4, each hub 120,120′ has an outer sleeve 130 that translates over a central shaft 110 of the tire building drum. The outer sleeve 130 is connected to T bolts 133. The T bolts 133 have an inner end 137 that are affixed to inner sleeve 139. Each inner sleeve 139 has an internal portion 141 that is threadedly engaged with the internal screw 114 for axial movement. Thus, axial movement of each hub 120 is by a controlled axial translation from the inner screw. The controlled axial translation or controlled velocity is determined experimentally, and is the rate of translation of each bead from the carcass tension during inflation under high inflation, low pressure air when the beads are freely slidable in the axial direction.

Each hub 120 further includes a bead lock mechanism 200 for receiving the bead area of the green carcass. Each bead lock mechanism 200 further includes a plurality of bead segments 210. Each bead segment 210 may expanded and contracted in a radial direction by bead actuating cylinders 220. Each bead locking mechanism 200 preferably utilizes zero or low pressure. Preferably the bead lock cylinder pressures range from zero to less than 5 bar, and more preferably from zero to 2 bar. The nonexistent or substantially reduced bead pressure is reduced to limit bead compression and prevent cold forging of the toe guard and chafer under the bead sole.

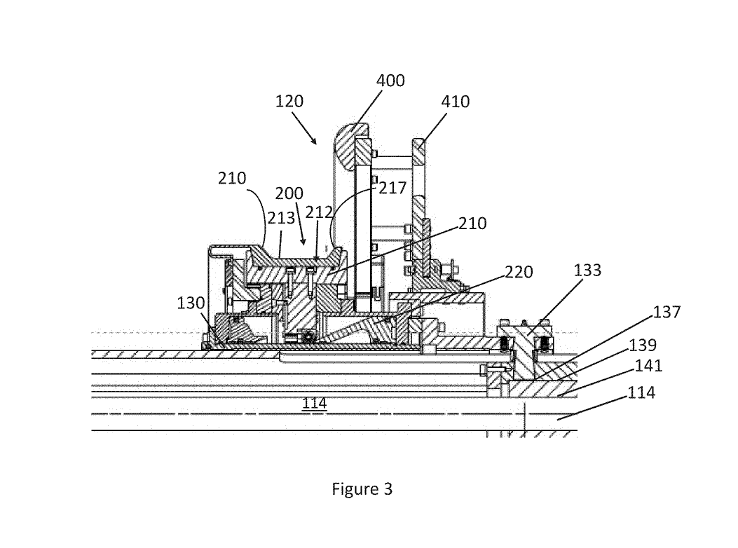

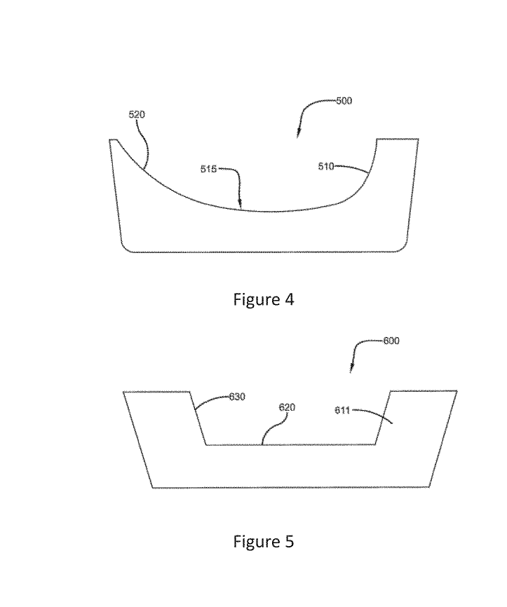

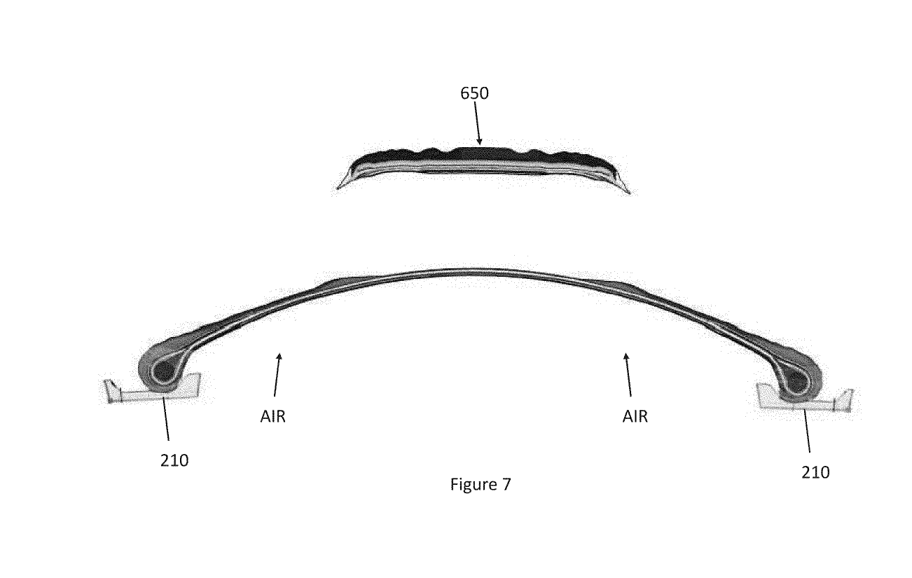

As shown in FIG. 3, each bead segment 210 has a bead pocket 212 that facilitates rotation of the tire around the bead area during shaping. Each bead pocket 212 gently holds and supports the bead without the need of any bead lock force. The bead pocket 212 as shown may have a flat bead receiving surface 213 with angled retaining sidewalls 215,217. The flat bead receiving surface 213 may be angled in the range of 0 to 15 degrees from horizontal. The bead pockets 212 allow the tire to rotate around the bead cable so that the tire down ply is pulled into tension and the apex is positioned at the cured ply line angle. The angled retaining sidewalls 215,217 retain the bead in the bead pockets during tire shaping, as shown in FIGS. 7-9. The pocket 212 may have a curved receiving surface 515 with a retaining wall 510 as shown in FIG. 4. Preferably, the pocket 212 is formed of an elastomer, more preferably urethane. The curve 515 may be symmetrical or asymmetrical in shape. FIG. 5 illustrates that the pocket 212 may have angled retaining walls 611,630. A flexible seal 214 is preferably integrally formed with the pocket 212, as shown in FIG. 1.

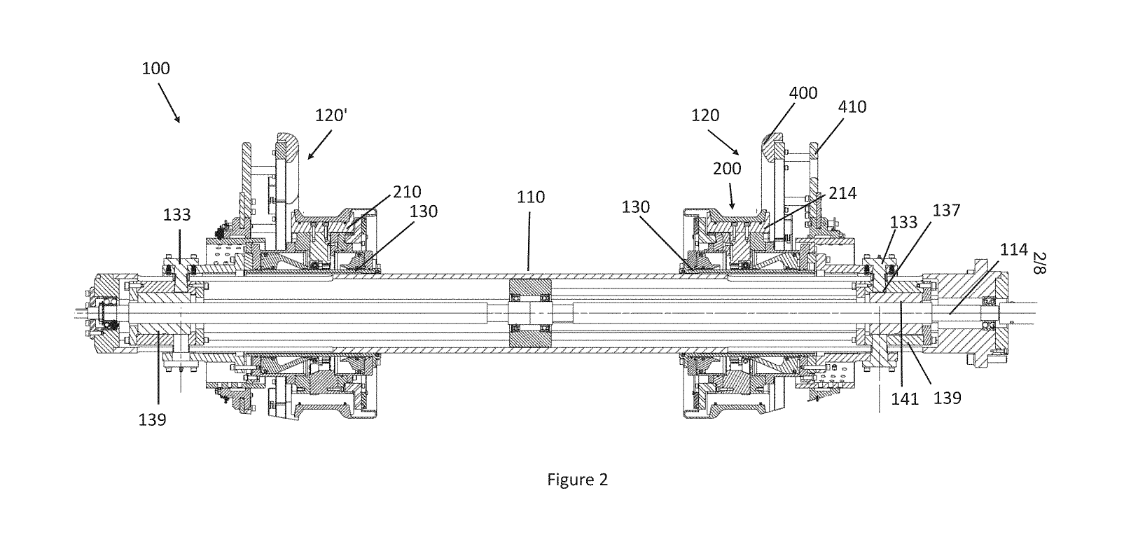

FIGS. 1-3 illustrate that the hubs 120 may further include an optional shaping plate 400. The optional shaping plate 400 is received in support brackets 410, as shown in FIG. 2. The optional shaping plate 400 may assist the shaping process by engaging the mid sidewall of the tire during the shaping process.

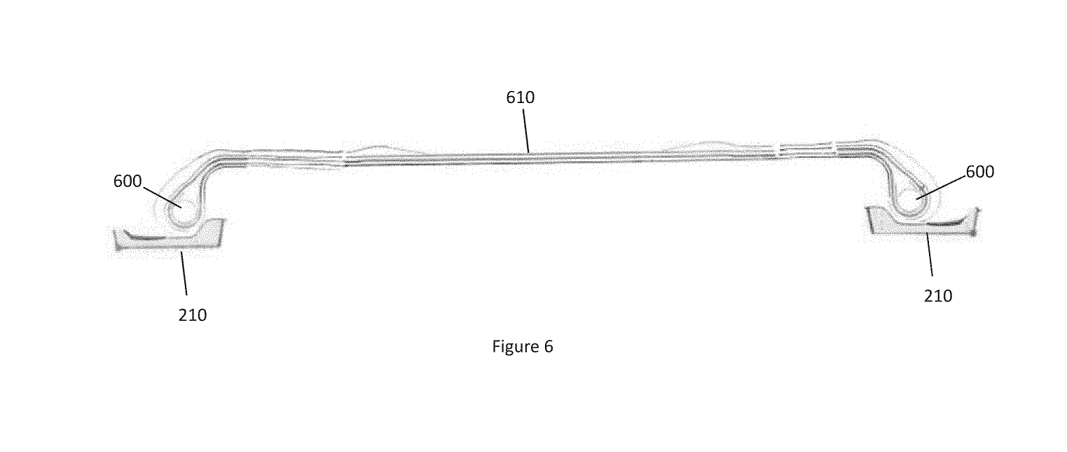

The first step of the catenary method of building tires begins with the tire building drum located in the start position as shown in FIG. 1. A cylindrically shaped green tire carcass 610 is mounted on the bead mechanisms 200 on each hub 120, so that a respective bead area 600 is received in the bead pocket 210 of a respective hub, as shown in FIG. 6.

The drum bead locking mechanisms 200 may optionally be radially expanded to exert a low pressure force on the beads sufficient to retain the bead in their axial position and allowing a tighter air seal of tire bead to the drum pocket seal and a more rapid carcass inflation while allowing rotation of the tire around the bead area 600.

After the green tire carcass is loaded, the next step is to shape the green carcass using the catenary shaping process of the invention. As the tire drum rotates, the green carcass 610 is quickly and properly inflated using low pressure, high volume shaping air as shown in FIG. 7. If the bead locking mechanisms 200 were positioned slightly inboard of the tire bead spacing, then the high volume low pressure air will inflate the carcass and draw the beads inward to the shoulder of the bead pocket. Utilizing high volume, low pressure air, the “b” distance (radial distance between the crown and beads) is increased and carcass cord tension remains at a low and calculated value. The carcass tension is controlled during inflation, each hub is relocated at a controlled velocity that simulates the axial translation of the beads caused by the carcass tension if the hubs could freely slide axially inwards towards the opposite hub. The controlled velocity is determined experimentally by measuring the rate of axial translation of the beads under carcass tension during inflation when the beads are free to axially move. For an aircraft tire, the controlled velocity is in the range of 7-12 mm/s, and more preferably 8-10 mm/s. For a passenger tire, the controlled velocity is in the range of 3-6 mm/s, and more preferably in the range of 4-5 mm/s. In an alternate embodiment, the internal driving screw 114 is de-clutched from the motorization, allowing free axial movement of the hubs with the bead pulling in forces generated by the catenary shaping process.

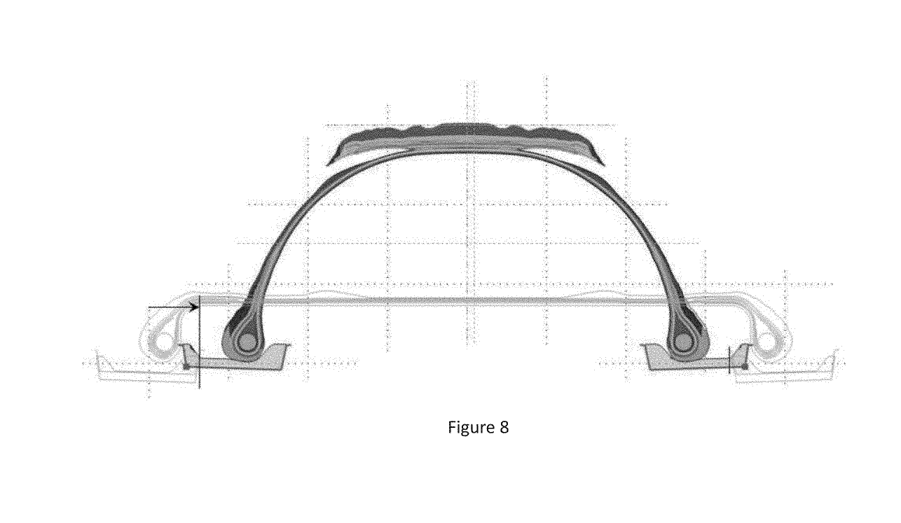

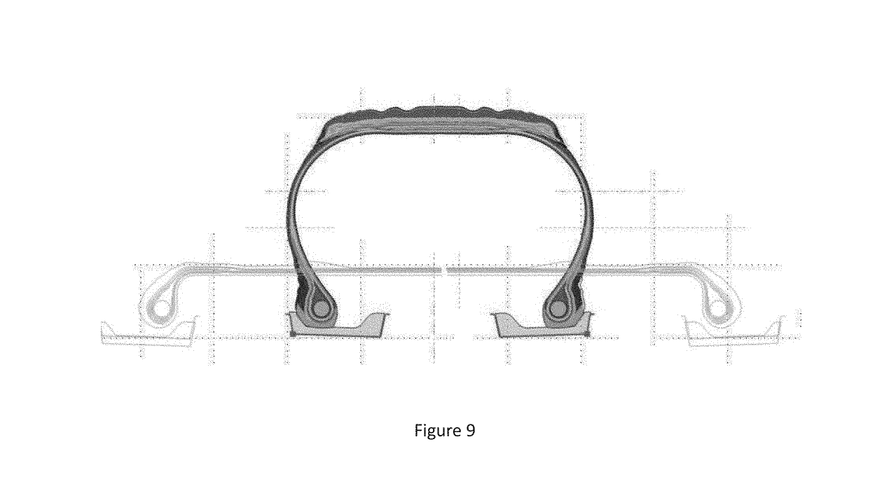

FIG. 6 illustrates the position of the beads in the bead pockets 210 of the green tire carcass when loaded onto the tire building drum. The assembled belt and tread package 650 is positioned over the inflating carcass 600 as shown in FIG. 7, and the carcass is inflated using high volume, low pressure air. The shape of the bead pockets allow the tire to rotate around the bead area during inflation without the need for high bead clamping forces. The bead lock forces can be zero or be minimal. The carcass 600 expands into the assembled belt and tread package 650 as shown in FIG. 8. When the sidewall angle is in the range of 55 degrees to 65 degrees, and the crown of the carcass has contacted the inside belt building diameter, the tire is at the neutral catenary shape where neither a tensile or compressive force is acting horizontally on the beads. Now both carcass and belt package share the same vertical centerline. As the beads are relocated closer and closer to the vertical centerline and the tire is shaped narrower than the catenary shape, the shaping air creates a force which slides the beads outward in the bead pocket, as shown in FIG. 9.

The carcass is inflated using high volume, low pressure air. The pressure preferably does not exceed 10 psi, and is more preferably less than 5 psi, and most preferably less than 3 psi. The flow rate is increased from prior art process so that the flow coefficient Cv rate is greater than 2. Preferably, the flow coefficient of the shaping air is greater than 4, and most preferably greater than 9.

Next, the tread and shoulder area is stitched to the carcass using low stitching pressure (not shown). The stitching pressure is in the range of 350 to 800 mbars, more preferably in the range of 500-700 mbars. The stitcher, using low pressure, starts at the center of the tread and stitches the tread in a circumferential manner, shifting axially outward from the center of the tire. The stitcher also stitches the tread shoulder interface and shoulder area. The completed tire is shown in FIG. 9, and the initial green tire carcass is shown in phantom. Then the tire is removed from the tire building drum completing the process. The green tire is then cured in a conventional mold.

The advantage of the catenary shaping process is that it does not produce any “ply pull through” which results in the distortion of the gauge of the inner liner and squeegee. The catenary shaping process with low bead locking force allows the outer lang wire of the cable bead to rotate freely without any elastic energy around the inner wires of the cable bead. The catenary shaping process with the low bead locking force allows the up plies and down plies which are contacting and adhering to the outer lang wire of the cable bead to rotate freely without any elastic energy around the inner wires of the cable bead. The catenary shaping process with the low bead locking forces provide for tension in the carcass up plies and down plies. Further the tension between up and down plies is harmonized.

While certain representative embodiments and details have been shown for the purpose of illustrating the invention, it will be apparent to those skilled in this art that various changes and modifications may be made therein without departing from the spirit or scope of the invention.

What is claimed is:

1. A method of forming a tire having a first and second bead on a tire building drum comprising the steps of:
applying a green tire carcass onto the tire building drum, said tire building drum having a left and right hub, each hub having a bead pocket;
placing the first and second bead onto a first and second respective bead pocket of the tire building drum;
inflating the carcass into engagement with a belt and tread package while moving at least one of the left and right hubs in the axial direction at a controlled velocity towards the other respective hub.

2. The method of claim 1 wherein both bead pockets are moved towards each other at a controlled velocity.

3. The method of claim 1 wherein the controlled velocity is less than 20 mm/s.

4. The method of claim 1 wherein the controlled velocity is less than 15 mm/s.

5. The method of claim 1 wherein the controlled velocity is less than 10 mm/s.

6. The method of claim 1 wherein the controlled velocity is less than 6 mm/s.

7. The method of claim 1 wherein no bead locking force is utilized.

8. The method of claim 1 further including the step of radially expanding the first and second bead receiving mechanisms into engagement with a respective first and second bead at a low pressure.

9. The method of claim 1 wherein the carcass is inflated with airflow having a flow coefficient Cv greater than 2.

10. The method of claim 1 wherein the carcass is inflated with airflow having a flow coefficient Cv of 5 to 10.

11. The method of claim 1 wherein the carcass is inflated with air at a pressure of less than 10 psi.

12. The method of claim 1 wherein the carcass is inflated with air at a pressure of less than 5 psi.

13. The method of claim 1 wherein the carcass is inflated with air at a pressure of less than 3 psi.

14. A method of forming a tire having a first and second bead on a tire building drum comprising the steps of:
applying a green tire carcass onto the tire building drum, said tire building drum having a first and second hub, said first hub having a first bead pocket, and said second hub having a second bead pocket;
placing the first and second bead onto the first and second respective bead pocket, inflating the carcass into engagement with a belt and tread package while allowing at least one of the first and second bead pockets to freely move in the axial direction.

15. The method of claim 14 wherein both first and second bead pockets are allowed to freely move in the axial direction.

16. The method of claim 14 further comprising the step of inflating the carcass with low pressure, high volume air.

17. The method of claim 14 wherein no bead locking force is utilized.

18. The method of claim 14 wherein the bead pockets are radially expanded with low bead locking force.

19. The method of claim 14 wherein the carcass is inflated with airflow having a flow coefficient Cv greater than 2.

20. The method of claim 14 wherein the carcass is inflated with airflow having a flow coefficient Cv of 5 to 10.

21. The method of claim 14 wherein the carcass is inflated with air at a pressure of less than 10 psi.

22. The method of claim 14 wherein the carcass is inflated with air at a pressure of less than 5 psi.

23. The method of claim 14 wherein the carcass is inflated with air at a pressure of less than 3 psi.
